(19) United States
(12) Patent Application Publication
(10) Pub. No.: US 2026/0058073 A1
(43) Pub. Date: Feb. 26, 2026

(54) Button Structure with Display

(71) Applicant: Anker Innovations Technology Co., Ltd., Changsha (CN)

(72) Inventors: Gaoming Li, Shenzhen (CN); Anfu Zeng, Shenzhen (CN); Yi Ouyang, Shenzhen (CN)

(21) Appl. No.: 19/299,898

(22) Filed: Aug. 14, 2025

(30) Foreign Application Priority Data
Aug. 23, 2024 (CN) 202422062097.0

(51) Int. Cl. H01H 13/02; H01H 9/18; H01H 13/52

(52) U.S. Cl. CPC H01H 13/023; H01H 9/182; H01H 13/52; H01H 2219/036; H01H 2219/062; H01H 2235/008

(57) ABSTRACT

Disclosed are a button structure and an electronic device. The button structure may be mounted on an outer shell. The button structure may comprise: a button cover having a display pattern; and a soft rubber comprising a deformation part and a connection part. The deformation part is connected to an inner surface of the button cap, and the connection part is configured to connect to an inner wall of the outer shell. The button structure may further comprise a circuit board comprising a light source and a button. Light emitted by the light source can be emitted through the display pattern.

### CROSS-REFERENCE TO RELATED APPLICATION

This application claims priority to CN Application No. 202422062097.0, filed Aug. 23, 2024, which is incorporated herein by reference in its entirety.

### FIELD

The present disclosure relates to the technical field of buttons (e.g., keys), in particular to a button structure and an electronic device.

### BACKGROUND

With the development of modern technology, users'requirements for electronic devices are increasing. In order to meet users'demands and improve operational convenience of electronic devices, manufacturers often provide buttons on the surface of the electronic device's housing, along with display patterns indicating the button functions. However, these two components are usually disposed separately, leading to a large occupied space within the housing and thus a large size of the electronic device, hindering the development of more compact electronic devices.

### SUMMARY

Examples of the present disclosure provide a button structure, a housing and an electronic device. A display pattern is disposed on a button cap to enable the button structure to have a display function, which can reduce the occupied space within the outer shell, so as to reduce the size of the outer shell, so that the size of the electronic device is small.

An example of the present disclosure provides a button structure mounted on an outer shell. The button structure may comprise: a button cover having a display pattern; and a soft rubber comprising a deformation part and a connection part. The deformation part is connected to an inner surface of the button cap, and the connection part is configured to connect to an inner wall of the outer shell. The button structure may further comprise a circuit board comprising a light source and a button. Light emitted by the light source can be emitted through the display pattern. The button structure may further comprise a compressing member connected to the circuit board.

An example of the present disclosure provides a housing comprising: an outer shell having a hole; and a button structure. At least part of the button structure is exposed via the hole. The compressing member is connected to the inner wall of the outer shell and presses the connection part.

An example of the present disclosure provides an electronic device comprising: a housing; and components disposed within the housing and electrically connected to the circuit board.

Based on the button structure of the present disclosure, by providing the display pattern on the button cap, and through the light source corresponding to the display pattern, the button structure may have a specific display function for the disposed display pattern, so that the user can identify the function of the button structure based on the display pattern and can operate the electronic device based on the display pattern. In this way, the above structure improves the convenience of the user to operate the electronic device and improves the user's operating efficiency. In addition, compared with a separate arrangement of the button structure and a display functional component, integration of the button structure and the display functional component results in a compact design of the button structure, reduces the occupied space of the button structure within the outer shell, so as to reduce the size of the outer shell and the size of the electronic device.

Further, since the compressing member may press the connection part, the connection part is elastically deformed to fill the gap between the compressing member and the outer shell, thereby reducing a probability of liquid entering the electronic device via the gap between the compressing member and the outer shell, to reduce the probability of damage to the components within the electronic device, so that the electronic device may have a long service life.

### BRIEF DESCRIPTION OF DRAWINGS

In order to more clearly illustrate technical solutions in the present disclosure or in the related art, drawings that need to be used in description of the examples or the related art are briefly introduced below, and it will be apparent to those of ordinary skill in the art that the drawings in the following description are merely some examples of the disclosure, and other drawings may be obtained in accordance with these drawings without inventive work.

FIG. 1 is a schematic structural diagram of an electronic device according to an example of the present disclosure;

FIG. 2 is a schematic exploded view of a button structure according to an example of the present disclosure; and

FIG. 3 is a schematic diagram showing a cross-sectional structure along line A-A in FIG. 1.

### DESCRIPTION OF REFERENCE SIGNS

1. electronic device; 2. housing; 21. outer shell; 21A. button hole; 3. button structure; 31. button cap; 311. main body; 311A. display pattern; 311B. light-transmitting opening; 312. light guide member; 3121. pattern part; 3122. pressing part; 32. soft rubber member; 321. deformation part; 321A. avoidance hole; 321B. light guide cavity; 322. connection part; 33. circuit board; 34. light-emitting member; 35. button; 36. compressing member.

### DETAILED DESCRIPTION

In order to make understanding of the object, technical solutions and advantages of the present disclosure clearer, the present disclosure will be described in further detail below with reference to the accompanying drawings. It should be understood that the specific examples described herein are only used to explain the disclosure and are not used to limit the disclosure.

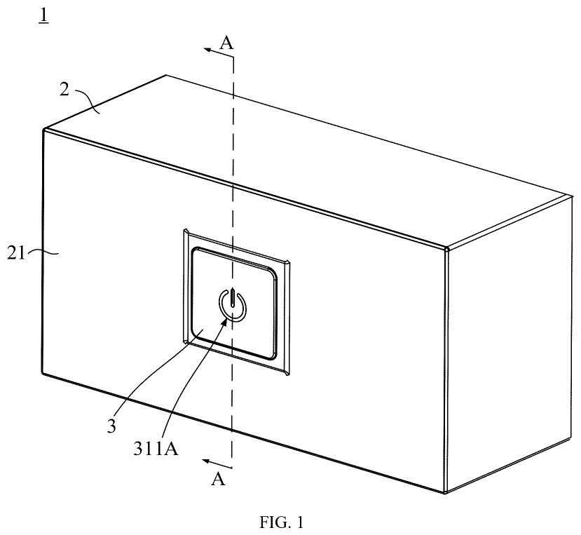

Referring to FIG. 1, an example of the present disclosure provides an electronic device 1, including a housing 2 and components disposed within the housing 2.

The housing 2 can support and protect the components disposed within the housing 2. The material of the housing 2 may be plastic or metal. Specifically, the material of the housing 2 may be plastic, so that the housing 2 is insulated, reducing the risk of electric shock to users. Moreover, since plastic is light in weight, the housing 2 is light in weight, and an overall weight of the electronic device 1 is light, which can improve portability of the electronic device 1. Specifically, the housing 2 may be integrally formed by injection molding, so that the housing 2 has high structural strength and is less prone to damage. This method can protect other components within the housing 2, and reduce the probability of damage to these other components, so that the electronic device 1 may have a long service life.

The electronic device 1 may be any one of a charging device, an energy storage device, a headphone, an earphone, an electric toothbrush, or a cleaning robot such as a sweeping robot. In other examples, the electronic device 1 may be a device of other forms and functions. A specific type or form of the electronic device 1 is not limited herein.

Referring to FIG. 1 to FIG. 3, in an example, the housing 2 may include an outer shell 21 and a button structure 3 (e.g., a key structure). The outer shell 21 has a hole 21A (e.g., a recess on the surface of the outer shell 21).

The button structure 3 may include a button cap 31 (e.g., a button cover), a soft rubber member 32, a circuit board 33, and a compressing member 36.

The button cap 31 has a display pattern 311A, and at least part of the button cap 31 is exposed via the button hole 21A to enable a user to press the button cap 31. For example, the display pattern 311A may include at least one of a function indication pattern, a Chinese character pattern, and/or an English character pattern. For example, the display pattern 311A may be a power pattern that indicates a power status of the electronic device 1 or a volume pattern that indicates a volume status of the electronic device 1. The button cap 31 may be circular, triangular, quadrilateral, or polygonal. The shape of the button cap 31 is not limited.

The soft rubber member 32 may include a deformation part 321 and a connection part 322 disposed around the deformation part 321. The deformation part 321 is connected to an inner surface of the button cap 31. The connection part 322 is configured to connect to an inner wall of the outer shell 21, so as to connect the button cap 31 to the outer shell 21. In addition, when a user presses the button cap 31, the button cap 31 moves within the button hole 21A toward the circuit board 33, so that the deformation part 321 undergoes elastic deformation. When the button cap 31 is released, the deformation part 321 returns to its original form, so as to push the button cap 31 to move away from the circuit board 33, which is convenient for the user to press the button cap 31 next time. For example, the material of the soft rubber member 32 may include at least one of silicone, rubber, thermoplastic polyurethane (TPU), thermoplastic elastomer (TPE), soft polyvinyl chloride (PVC), or polyurethane (PU). In other examples, the soft rubber member 32 may be made of other materials.

The circuit board 33 may include a light-emitting member 34 (e.g., a light source) and a button 35 (e.g., a key), and the button cap 31 is disposed corresponding to the button 35. The light emitted by the light-emitting member 34 exits via the display pattern 311A to illuminate the display pattern 311A, so as to facilitate the user to identify the function of the button 35. For example, the light-emitting member 34 may be at least one of a lamp bead, a light bar, or a display screen. The specific form of the light-emitting member 34 is not limited. The light-emitting member 34 may include LED lamp beads of different colors, so that the display pattern 311A may display different colors.

The compressing member 36 may be connected to the inner wall of the outer shell 21 and may press the connection part 322, so that the connection part 322 may be deformed to fill a gap between the compressing member 36 and the outer shell 21, thereby reducing a probability of liquid entering the electronic device 1 through the gap between the compressing member 36 and the outer shell 21 and thus a probability of damage to components. Therefore, the components may have a long service life, and thus the electronic device 1 may have a long service life. For example, the compressing member 36 may be screwed or glued to the outer shell 21, so that the compressing member 36 is stably connected to the outer shell 21, and the circuit board 33 is also connected to a side of the compressing member 36 facing the outer shell 21, so that the circuit board 33 may be fixed through the compressing member 36 to ensure that when the user presses the button cap 31, the button cap 31 may trigger the button 35, so that the electronic device 1 can respond to the user's operation. The compressing member 36 may be a block-like object such as a plastic block, a soft rubber block, a retainer plate, or a baseplate, and it can be either rigid or capable of elastic deformation.

In an example, by providing the display pattern 311A on the button cap 31, and through the light-emitting member 34 corresponding to the display pattern 311A, the button structure 3 may have a specific display function for the disposed display pattern 311A, so that the user can identify the function of the button structure 3 based on the display pattern 311A and can operate the electronic device 1 based on the display pattern 311A. This structure and method can improve the convenience of the user to operate the electronic device 1 and improve the operating efficiency. In addition, compared with a separate arrangement of the button structure 3 and a display functional component, integration of the button structure 3 and the display functional component may reduce the occupied space within the outer shell 21, and thus reduce the size of the outer shell 21. In this way, the size of the electronic device 1 is small.

Further, since the compressing member 36 may press the connection part 322, the connection part 322 can be elastically deformed to fill the gap between the compressing member 36 and the outer shell 21, thereby reducing a probability of liquid entering the electronic device 1 via the gap between the compressing member 36 and the outer shell 21, so as to reduce the probability of damage to the components within the electronic device 1, so that the electronic device 1 may have a long service life.

The components within the housing 2 may be electrically connected to the circuit board 33, so that the user may press the button cap 31 to cause the button 35 to generate a corresponding electrical signal, and the circuit board 33 can control a corresponding component to perform preset operation based on the corresponding electrical signal. For example, when the electronic device 1 is a charging device, the user may press the button cap 31 to control an output port to supply power to an external device or stop supplying power to the external device. For example, when the electronic device 1 is an electric toothbrush, the user may press the button cap 31 to control operation of a motor to drive movement of a brush head, so as to clean the user's teeth. Alternatively, the user may press the button cap 31 to control the motor to stop operation.

Referring to FIG. 1 to FIG. 3, in an example, the button cap 31 may include a main body 311 and a light guide member 312. The main body 311 has the display pattern 311A and is connected to the deformation part 321. The light guide member 312 may be connected to the main body 311, may extend toward the button 35, and may be disposed corresponding to the button 35. When the user presses the main body 311, the main body 311 moves toward the button 35, and the light guide member 312 moves toward the button 35 to trigger the button 35. The light guide member 312 may be disposed corresponding to the display pattern 311A, and the light emitted by the light-emitting member 34 may emit (e.g., exit) via the light guide member 312 and the display pattern 311A to illuminate the display pattern 311A, so as to facilitate the user to identify the function of the button 35 and improve the user's operation accuracy.

Referring to FIG. 1 to FIG. 3, specifically, the deformation part 321 may have an avoidance hole 321A and a light guide cavity 321B. The light guide cavity 321B may communicate with the avoidance hole 321A. An end of the light guide member 312 away from the main body 311 may pass through the avoidance hole 321A and extend in the light guide cavity 321B. The light-emitting member 34 may be disposed corresponding to the light guide cavity 321B. The light emitted by the light-emitting member 34 may enter the light guide cavity 321B and emit via the light guide member 312 and the display pattern 311A to illuminate the display pattern 311A, so as to provide a display function for the user. The display pattern 311A may include at least one of a transparent part or a light-transmitting opening 311B.

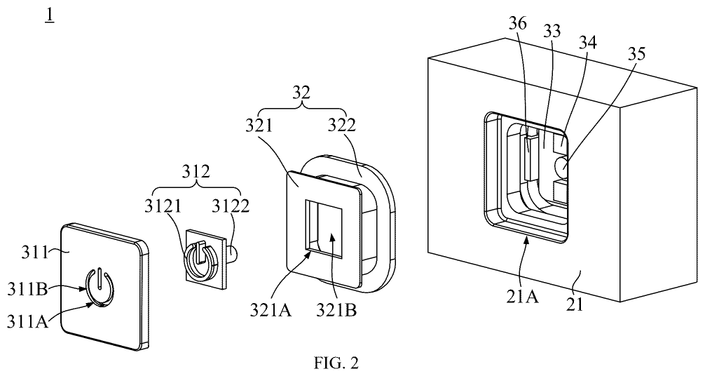

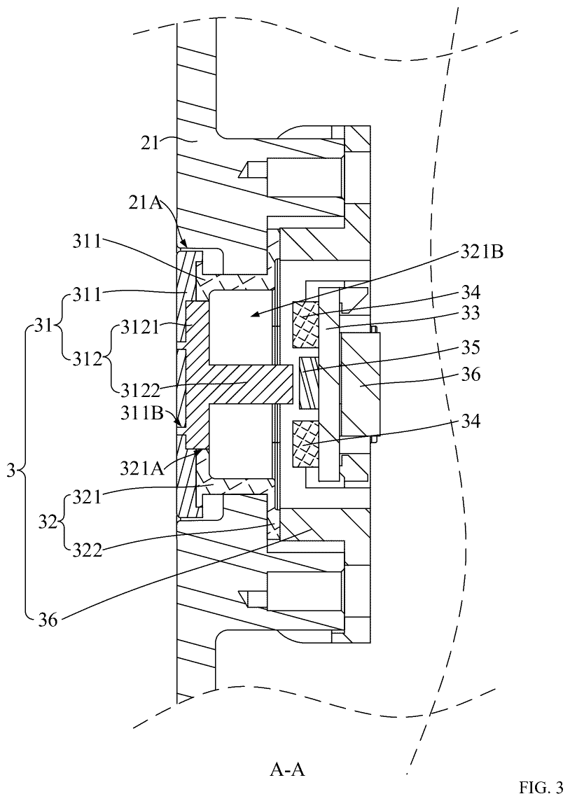

Referring to FIG. 2 and FIG. 3, specifically, the main body 311 may have a light-transmitting opening 311B, and the light guide member 312 may have a pattern part 3121 (e.g., a pattern to be displayed on the button cap) and a pressing part 3122. The pattern part 3121 may be embedded in the main body 311 and partially exposed through the light-transmitting opening 311B to form the display pattern 311A. The light emitted by light-emitting member 34 may be transmitted to the pattern part 3121 through the pressing part 3122 and may be emitted via the light-transmitting opening 311B to illuminate the display pattern 311A. The pressing part 3122 is disposed corresponding to the button 35. When the user presses the button cap 31, the main body 311 moves toward the button 35, so that the pressing part 3122 moves toward the button 35 to trigger the button 35.

The pattern part 3121 may be bonded to an inner wall of the light-transmitting opening 311B to improve connection stability between the pattern part 3121 and the main body 311. When the user presses the button cap 31, it can ensure that the pressing part 3122 can trigger the button 35 to respond to the user's operation.

Referring to FIG. 1 to FIG. 3, in the examples of the present disclosure, the main body 311 and the light guide member 312 may be made of plastic. The main body 311 and the pattern part 3121 can be integrally formed through a secondary injection molding process, so as to eliminate the gap between the main body 311 and the pattern part 3121, thereby preventing liquid from entering the button structure 3 through the gap between the main body 311 and the pattern part 3121. In this way, the probability of damage to the button structure 3 may be reduced, so that the button structure 3 may have a long service life, and the electronic device 1 may have a long service life.

In addition, since the main body 311 and the pattern part 3121 may be integrally formed through the secondary injection molding process, the gap between the main body 311 and the pattern part 3121 is eliminated, which can reduce a probability of dirt and grime hidden in the gap between the main body 311 and the pattern part 3121, improve convenience for users to clean the electronic device 1, and provide reliable guarantee for the user's health.

Further, the main body 311 and the pattern part 3121 may be integrally formed through the secondary injection molding process, compared with the main body 311 bonded to the pattern part 3121, which may omit a step of assembling the main body 311 and the pattern part 3121 so as to reduce assembly steps of the button structure 3, thereby improving assembly efficiency of the button structure 3, and further improving assembly efficiency of the electronic device 1.

It may be understood that the main body 311 and the pattern part 3121 may be integrally formed through a two-color injection molding process, which may also help eliminate the gap between the main body 311 and the pattern part 3121 and thus reduce the assembly steps of the button structure 3, thereby improving the assembly efficiency of the electronic device 1. Details of this will not be repeated in the examples of the present disclosure.

Referring to FIG. 1 to FIG. 3, in an example, the inner surface of the main body 311 may be bonded to or screwed to the deformation part 321 to improve the connection stability between the deformation part 321 and the main body 311. In this way, after the user presses the button cap 31, the deformation part 321 may push the main body 311 to move away from the button 35, which is convenient for the user to press the button cap 31 next time.

Referring to FIG. 1 to FIG. 3, in the examples of the present disclosure, both the main body 311 and the deformation part 321 may be made of plastic. The main body 311 and the deformation part 321 may be integrally formed through the secondary injection molding process to eliminate the gap between the main body 311 and the deformation part 321, so as to prevent liquid from entering the button structure 3 through the gap between the main body 311 and the deformation part 321. In this way, the probability of damage to the button structure 3 may be reduced, so that the button structure 3 may have a long service life, and the electronic device 1 may have a long service life.

Further, since the main body 311 and the deformation part 321 may be integrally formed through the secondary injection molding process, compared with the main body 311 bonded to the deformation part 321, which may omit the step of assembling the main body 311 and the deformation part 321, so as to reduce the assembly steps of the button structure 3, thereby improving the assembly efficiency of the button structure 3, and thus improving the assembly efficiency of the electronic device 1.

The main body 311 and the deformation part 321 may also be integrally formed through a two-color injection molding process, which may also help eliminate the gap between the main body 311 and the deformation part 321, and may reduce the assembly steps of the button structure 3, thereby improving the assembly efficiency of the electronic device 1. Details of this will not be repeated in the examples of the present disclosure.

Referring to FIG. 1 to FIG. 3, in the examples of the present disclosure, the main body 311, the pattern part 3121 and the deformation part 321 may be integrally formed, which may reduce the assembly steps of the button structure 3 and reduce assembly complexity of the button structure 3, thereby improving the assembly efficiency of the button structure 3 and thus improving the assembly efficiency of the electronic device 1.

The same or similar reference signs in the drawings of the examples correspond to the same or similar parts. In the description of the present disclosure, it should be understood that the terms “upper”, “lower”, “left”, “right”, and the like indicating orientation or position relationships are based on orientation or position relationships shown in the drawings, and are intended to describe the disclosure and simplify descriptions only and not to indicate or imply that the referred device or element must be provided, configured and operated in a particular orientation. Therefore, the terms used to describe position relationships are intended to be illustrative only and are not intended to limit the present disclosure. For those skilled in the art, specific meanings of the above terms can be understood according to specific situations.

The above are only preferred examples of the present disclosure and are not intended to limit the disclosure. Any modifications, equivalent substitutions, improvements or the like within the spirit and principle of the disclosure should be included in the scope of the disclosure.

What is claimed is:

1. A button structure mounted on an outer shell, the button structure comprising:
a button cap having a display pattern;
a soft rubber comprising a deformation part and a connection part disposed around the deformation part, wherein the deformation part is connected to an inner surface of the button cap, and the connection part is configured to connect to an inner wall of the outer shell; and
a circuit board comprising a light source and a button, wherein light emitted by the light source is emitted through the display pattern.

2. The button structure of claim 1, wherein the button cap comprises:
a main body having the display pattern and connected to the deformation part; and
a light guide member connected to the main body and extending toward the button, wherein the light emitted by the light source is emitted via the light guide member and the display pattern.

3. The button structure of claim 2, wherein:
the deformation part has a hole and a light guide cavity coupled to the hole,
an end of the light guide member away from the main body passes through the hole and extends in the light guide cavity, and
the light emitted by the light source enters the light guide cavity and exits via the light guide member and the display pattern.

4. The button structure of claim 2, wherein the display pattern comprises at least one of a transparent pattern or a light-transmitting opening.

5. The button structure of claim 2, wherein:
the main body has a light-transmitting opening,
the light guide member has a pattern part and a pressing part, and
the pattern part is embedded in the main body and partially exposed through the light-transmitting opening to form the display pattern.

6. The button structure of claim 1, further comprising:
a compressing member connected to the circuit board, wherein the compressing member is configured to connect to the inner wall of the outer shell and press the connection part.

7. The button structure of claim 2, wherein the deformation part is integrally formed with the main body.

8. The button structure of claim 1, wherein the display pattern includes at least one of a function indication pattern, or one or more characters.

9. An electronic device comprising:
a housing; and
a button structure in the housing, comprising:
a button cap having a display pattern;
a soft rubber comprising a deformation part and a connection part disposed around the deformation part, wherein the deformation part is connected to an inner surface of the button cap, and the connection part is configured to connect to an inner wall of the housing; and
a circuit board comprising a light source and a button, wherein the light source is configured to emit light through the display pattern.

10. The electronic device of claim 9, wherein the button cap comprises:
a main body having the display pattern and connected to the deformation part; and
a light guide member connected to the main body and extending toward the button, wherein the light emitted by the light source is emitted via the light guide member and the display pattern.

11. The electronic device of claim 10, wherein:
the deformation part has a hole and a light guide cavity coupled to the hole,
an end of the light guide member away from the main body passes through the hole and extends in the light guide cavity, and
the light emitted by the light source enters the light guide cavity and exits via the light guide member and the display pattern.

12. The electronic device of claim 10, wherein the display pattern comprises at least one of a transparent pattern or a light-transmitting opening.

13. The electronic device of claim 10, wherein:
the main body has a light-transmitting opening,
the light guide member has a pattern part and a pressing part, and
the pattern part is embedded in the main body and partially exposed through the light-transmitting opening to form the display pattern.

14. The electronic device of claim 13, wherein the pattern part is integrally formed with the main body.

15. The electronic device of claim 10, wherein the deformation part is integrally formed with the main body.

16. The electronic device of claim 10, wherein the display pattern includes at least one of a function indication pattern, or one or more characters.

17. An electronic device, comprising:
a button cover comprising a display;
a circuit board comprising a light source and a button; and
a compressing member connected to the circuit board, wherein the compressing member is configured to press a soft rubber in response to pressing the button cover, wherein:
the button cover is coupled to the button, and
the light source is configured to emit light through the display.

18. The electronic device of claim 17, wherein in response to pressing the button cover, the button is triggered to generate an electrical signal associated with the light.

19. The electronic device of claim 17, wherein the electronic device comprises at least one of a charging device, an electric toothbrush, an energy storage device, or an earphone.

20. The electronic device of claim 17, wherein the button cover is coupled to the button via a light guide member, and wherein the light guide member comprises a pattern part and a pressing part.
